(19) United States
(12) Patent Application Publication
(10) Pub. No.: US 2015/0375023 A1
(43) Pub. Date: Dec. 31, 2015

(54) Fire-Extinguishing Binary Chemical Condensation Composition and Apparatus for Extinguishing Fires

(71) Applicants: Vladimir Ivanovich Seliverstov, Moskovskaya obl (RU); Dmitrity Dmitrievich Osmakov, Moskovskaya obl. (RU); Lev Vladislavovich Rzhavskiy, Moskovskaya obl. (RU); Anton Vladislavovic Stepanov, Moskovskaya obl. (RU); Galina Valdimirovna Trubnikova, Moskovskaya obl. (RU); Valeriy Leonidovich Bakharey, Moskovskaya obl. (RU); Vyacheslav Mikhailovich Minashkin, Moskovskaya obl. (RU); Vladimir Ilyich Stenkovoy, Moskovskaya ob. (RU); Pavel Gennadievich Veretinskiy, Moskovskaya obl. (RU); Pavel Valerievich Kukshin, Moskovskaya obl. (RU)

(72) Inventors: Vladimir Ivanovich Seliverstov, Moskovskaya obl (RU); Dmitrity Dmitrievich Osmakov, Moskovskaya obl. (RU); Lev Vladislavovich Rzhavskiy, Moskovskaya obl. (RU); Anton Vladislavovic Stepanov, Moskovskaya obl. (RU); Galina Valdimirovna Trubnikova, Moskovskaya obl. (RU); Valeriy Leonidovich Bakharey, Moskovskaya obl. (RU); Vyacheslav Mikhailovich Minashkin, Moskovskaya obl. (RU); Vladimir Ilyich Stenkovoy, Moskovskaya ob. (RU); Pavel Gennadievich Veretinskiy, Moskovskaya obl. (RU); Pavel Valerievich Kukshin, Moskovskaya obl. (RU)

(21) Appl. No.: 14/350,102

(22) PCT Filed: Nov. 22, 2011
(86) PCT No.: PCT/RU2011/000917

§ 371 Date: Sep. 10, 2015

(30) Foreign Application Priority Data
Oct. 5, 2011 (RU) 2011140521
Oct. 5, 2011 (RU) 2011140522

(51) Int. Cl. A62C 35/02; A62D 1/00; B05B 1/02

(52) U.S. Cl. CPC A62C 35/023; B05B 1/02; A62D 1/0035

(57) ABSTRACT

Fire-extinguishing composition comprising a gaseous phlegmatizer propellant of carbon dioxide mixed with nitrogen or air, a liquid alkaline phlegmatizer which is a mixture of aqueous ammonia with neutral inhibitor, namely fluorinated film-forming foaming agent and/or solution of a caesium salt in ratio of aqueous ammonia to neutral inhibitor ranging from 99:1 to 80:20, and acid neutralizer and propellant consisting of a carbon dioxide mixture, pressure stabilizer, namely nitrogen or air, and antifreeze in volume ratio ranging from 80:15:5 to 97:2:1. Device comprises a tank with chemical inhibitor, gas cylinder connected to cavity of said tank by tube aerator, start-intake device, and outlet pipe connected to a tubular nozzle atomizer via a valve. There are no fewer than 3 slit-like nozzles with reduced angle of inclination relative to the horizontal. Furthest nozzle from end of atomizer is perpendicular to horizontal, and dispersion vector of end nozzle is parallel to horizontal.

### CROSS-REFERENCE TO RELATED APPLICATION

This application is a national stage patent application that claims the benefit of the priority filing date in PCT/RU2011/000917 and referenced in WIPO Publication No. WO/2013/051957 filed on Nov. 22, 2011. The earliest priority date claimed is Oct. 5, 2011.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates to fire-fighting equipment—namely, to fire-extinguishing binary chemical condensation compositions and to the apparatus employing said compositions.

The proposed fire-extinguishing composition and apparatus of the present invention as well as the means and systems based thereupon can be successfully utilized for fighting and preventing fires in virtually every branch of industry, such as chemical, petrochemical exploration and production, and woodworking industry and for the protection of civil buildings from fires.

### PRIOR ART

A binary chemical condensation composition comprising an alkaline component based on liquid ammonia or the derivatives thereof combined with a gas propellant and an acid component consisting of 50%-80% aqueous solution of phosphoric acid and carbon dioxide or a mixture of carbon dioxide with air (RF Patent #2393901, filed 7 Oct. 2008) is known in the art.

The first disadvantage of said composition is high chemical reactivity of phosphoric acid, which requires the use of very expensive highly alloyed steel containers (see N. N. Postnikov “Thermal Acids, Salts, and Fertilizers Based on such Acids” M. “Khimia”, 1976, p. 335); the second disadvantage is that using liquid ammonia in industry is hazardous due to the high toxicity of ammonia gases and possible thermal burns (local supercooling) on contact with skin; and third, a mixture of gaseous ammonia and air is flammable.

The main disadvantage of said binary chemical condensation composition, which is the closest analog to the present invention, is low exothermicity thereof, which, at the time of fire-fighting operations in a fire zone, during synthesis of the fire-extinguishing agent (FEA) ammonium phosphate, does not produce enough water vapor to bring the oxygen concentration in the fire zone down to the critical value.

Fire extinguishers, fire-fighting modules and devices for 3D and areal fire fighting with gas-dispersion compositions are known in the art (RF Patent #2362599, RF Patent #2355450, RF Patent #2393901, RF Patent #2283154, RF Patent #2258549, patent application PCT WO 2008/103065A1, patent application #2010106910 dated Feb. 24, 2010.).

All said apparatus work on the same principle based on the injection of a phlegmatizer propellant gas through a pipeline equipped with a lock-and-release device into a tank charged with a dispersed chemical inhibitor, creating a gas-dispersion suspension (fire extinguishing composition) therein (in the tank), i.e. an FEA, followed by the transfer thereof via a membrane valve and a perforated atomizer nozzle into the fire zone.

The disadvantage of all such apparatus is the uneven distribution of an FEA throughout the entire tank, which is caused by two factors. The first factor is: the highest possible amount of finer jets is required to provide a more uniform FEA distribution throughout the tank. That, in turn, sharply reduces the effective range of the FEA jets, i.e., creates the following alternative dependence: either the FEA is uniformly dispersed throughout the tank but remains in rather close proximity to the FEA generation source or the powerful jets are far-reaching but unevenly dispersed throughout the volume. An obvious conclusion is that such construction requires either conduits or a multitude of fire-fighting apparatus to be placed within the protection boundaries or in the area of operation.

The closest atomizer nozzle apparatus and the model itself are described in the RF useful model patent #83926, class A62C 13/62, A62C 35/02 dated Jan. 15, 2008, “Gas Powder Fire Extinguisher,” which was chosen as a prototype. Said gas powder fire extinguisher comprises a barrel containing a powdered FEA inhibitor and a phlegmatizer propellant gas, a lock-and-release device, a dip tube, and an inlet pipeline to send the FEA under the 1.2-30 mPa pressure into a pipe atomizer nozzle with the total discharge area equal to 0.4-0.95 of the area of the inlet atomizer nozzle pipeline, wherein said atomizer nozzle is made in the shape of a cylinder with the outer diameter equal to 1.5-1.7 of the inner central channel diameter, while the outer surface comprises at least two circular tapered grooves with various inclination angles of cylinder elements, wherein the generatrices of said grooves comprise radial cylindrical atomizer nozzles or diffuser atomizer nozzles tapering at 3-15°, with the axes thereof perpendicular to the generatrices, wherein the inclination angles between the axes of the radial diffusers and the axis of the central channel of the atomizer nozzle gradually taper from 80-90° to 15-30°.

The disadvantage of said apparatus when used as an independent fire-fighting module or as a fire-extinguishing unit is the uneven FEA distribution throughout the tank, which, as a result, reduces the specific capability of fire control. For instance, gas-powder fire fighting module MΠΠ7.5-3-K [symbol] 1-Y2, wherein the FEA's weight is 8.5 kg, provides fire suppression in the 45 m³ volume, i.e., Cₛᵤₚ=0.19 kg/m³, which is substandard for the present-day fire-fighting equipment.

### SUMMARY

The objective of the present invention is to provide a water-based fire-extinguishing binary chemical condensation composition exhibiting higher heat release rates during convergence (namely spraying), which facilitates the conversion of water into vapor and, as a result, increases the fire-fighting efficiency while improving environmental friendliness, performance, and safety and lowering the overall cost. Spraying and mixing of the binary composition yields cluster-type finely dispersed aerosol.

Said objective is achieved by preparing a fire-extinguishing binary chemical condensation composition comprising a gaseous phlegmatizer propellant carbon dioxide mixed with nitrogen or air; liquid alkaline phlegmatizer aqueous ammonia or derivatives thereof, wherein said alkaline phlegmatizer is a mixture of aqueous ammonia with the chemical formula NH₃xnH₂O, where n=0.5÷4; and a neutral inhibitor fluorinated with a film-forming foaming agent and/or a cesium salt solution (halide, sulfate, phosphate, carbonate) in the following ratio: aqueous ammonia/neutral inhibitor: from 99:1 to 80:20; and the acid neutralizer/propellant mixture is a mixture of dioxide and a pressure stabilizer—namely, nitrogen or air, and antifreeze—namely, alkyl carbinol and/or alkyl ketone in the following composition component ratio (wt. %):

alkaline phlegmatizer with neutral inhibitor—30-60,
acid neutralizer/propellant—remaining

The spirit of the invention is in the use of internal energy—namely, enthalpy of the initial components during synthesis of a new fire-extinguishing compound; said enthalpy, according to the laws of thermodynamics, can be either positive, when the reaction is exothermic and releases heat, or endothermic, when synthesis is conducted with applied heating. The present invention provides two types of reactions to obtain ammonium phosphate and ammonium carbonate:

NH₃+H₃P0₄→NH₄H₂P0₄+826 kJ/kg

NH₃+NH₄H₂P0₄→(NH₄)₂HP0₄+780 kJ/kg

In other words, the reaction to prepare 1 kg of ammophos, which is a mixture of mono- and diammonium phosphate, releases an average of ˜800 kJ.

Since 70% phosphoric acid is used in the reaction, the released energy is 800 kJ×0.7=560 kJ.

When converted into vapor, i.e., at t≧100° C., 1 dm³ of water releases 1,700 dm³ of vapor, i.e., 1 kg of water yields 1.7 m³ of vapor. Conversion of water into vapor at t=0° C. requires 2,675 kJ/kg, or 640 kcal/kg. Thus, according to the patent analog, in the synthesis of 1 kg of ammophos, 560 kJ:2,675 kJ=0.2 kg of water is converted into vapor, which is equal to 1.7 m³/kg×0.2 kg=0.34 m³ of vapor.

According to the proposed invention, the reaction is as follows:

NH₃xH₂O+CO₂→NH₄HC0₃+2,177 kJ/kg

Already at 70° C., ammonium bicarbonate breaks down to NH₄OH, a strong fire retardant, and carbon dioxide CO₂, a phlegmatizer. Thus, 1 kg of the thermal mixture of the binary composition according to the present invention yields 0.45 kg of ammonium hydroxide NH₄OH and 0.55 kg of CO₂, which corresponds to 1 m³ of CO₂. According to the shown reaction, 3.4 kg of water can be converted into vapor, i.e. the reaction can yield 1.7 m³×0.8 kg=1.38 m³ of vapor and 1 m³ of carbon dioxide. Thence, gas capacity of the phlegmatizer of the proposed composition can exceed gas capacity of the analog according to patent RF #2393901 sevenfold. Aqueous ammonia is a liquid fertilizer, which is not only noncorrosive, low toxic, and environmentally friendly, but also more cost-effective than phosphoric acid. Notably, aqueous ammonia readily dissolves cesium salts, which upon concentration from solutions form cluster aerosols.

As the dispersed phase of the formed aerosol is stable to coagulation, it facilitates the formation of an FFF, a fluorinated film-forming foaming agent, which confers a certain electric charge to aerosol particles and thus, impedes coagulation of ultra-dispersed particles in the fire-fighting aerosol.

The proposed ingredient combination in the proposed ratio thereof provides a composition with desired properties, which may achieve the desired technical result—in particular, an increased heat release and more effective fire fighting.

The set objective is additionally achieved by using an apparatus for extinguishing fires caused by flammable gases, liquids, and solids, comprising a tightly sealed tank containing a chemical fire retardant, a gas source (gas cylinder) connected to the interior of said tank with a pipe aerator, which facilitates the injection of said inhibitor through a lock-and-release device (LRD), and an outlet pipeline connected to a pipe atomizer nozzle via a membrane, mechanical, or electric valve, wherein said atomizer nozzle comprise at least 3 slots with tapering inclination angles relative to the horizontal, wherein the nozzle most remote from the atomizer end is perpendicular to the horizontal, the dispersion vector of the end atomizer nozzle is parallel to the horizontal, and the slant height of the slots is calculated as follows:

$${l}_{i} = 2 {\int }_{{ϕ}_{0}}^{90} \sqrt{1 + {tg}^{2} {α}_{i} \cdot cos ϕ} d ϕ ,$$

where
I₁— slant height of the i-th slot, m
α—inclination angle of the i-th slot, degree
φ—end aperture angle of the slot, degree

$${ϕ}_{0} = \frac{{180}^{0} - ψ}{2} , rpa ;$$

degree

And the slot width is calculation as follows:

$$δ = \frac{\cdot {S}_{TP} - {S}_{T}}{2 {\sum }_{i = 1}^{n} {\int }_{{ϕ}_{0}}^{{90}^{0}} \sqrt{1 + {tg}^{2} α \cdot cos ϕ} d ϕ}$$

where δ is the width of the i-th slot, m

K_{D}—orificing factor of the atomizer, which is calculated as a ratio between the cumulative sum of the nozzle atomizer areas Sₐₜₒₘ, m² and the end area of the outlet pipe S_{T}_{ₚ}m²; S_{T}—area of the end nozzle of the atomizer, m², wherein the chemical inhibitor in the sealed tank is alkaline, the propellant gas in the cylinder is acidic, and when mixed, they produce an exothermic reaction.

For a composition of neutral components (pH≈7), for example, for a mixture of a powdered composition like “Phoenix—70” and tetrafluoromethane, both solid and liquid inhibitors and the gaseous phlegmatizer propellant are held in the same tank equipped with a pressure-controlling device.

The modular apparatus filled with a chemical condensation (or a gas-dispersion) composition according to the present invention combined with an alkaline atomizer extinguishes fire in the volume of up to 95 m³, i.e. fire-fighting capacity C_{ff}=90 g/m³, which shows that fire-fighting efficiency increased more than two-fold relative to the prototype.

### DRAWINGS

The invention is illustrated by the accompanying drawings 1-5.

FIG. 1 shows an apparatus for extinguishing fires of flammable gases, liquids, and solids comprising a slotted nozzle charged with a binary chemical condensation composition.

The claimed composition is a gas-dispersion fire-extinguishing module comprising: sealed tank 1 charged with alkaline chemical inhibitor 2, pipe aerator 3, outlet pipe 4, membrane, mechanical, or electrical valve 5, slotted nozzle 6, lock-and-release device 7 equipped with a separate electric and/or manual starter, gas cylinder 8 charged with propellant gas 9.

FIG. 2 shows an apparatus, which is a monoblock gas-dispersion module with a slotted nozzle for a 3D fire fighting of flammable gases, liquids, and solids.

The claimed composition comprises: gas cylinder 1 charged with gas-dispersion composition 2 and 9, aerator pipe 3 for the conversion of solid or liquid fire retardants into an aerosol, outlet pipe 4, lock-and-release device 5, slotted nozzle 6, pressure-controlling device—barometric pressure censor 10.

FIG. 3 shows a side view of the slotted nozzle with different inclination angles relative to the horizontal \acute{α}.

FIG. 4 shows different variants of the end aperture angle ψ of the slotted nozzle.

FIG. 5 shows different variants of the end nozzle.

### DESCRIPTION OF PREFERRED EMBODIMENT

Ingredients of the composition are commercially available, plentiful, inexpensive, environmentally friendly, and noncorrosive.

The proposed fire-extinguishing binary chemical condensation composition is charged into two separate cylinders: acidic and alkaline. The first cylinder is charged with carbon dioxide (main propellant), nitrogen or air (pressure stabilizer, which inhibits carbon dioxide's highly sensitive barometric pressure fluctuations with temperature), and antifreeze, such as ethyl alcohol and/or dimethyl ketone). The alkaline cylinder is charged with aqueous ammonia, surfactant, and cesium salts solution. Cesium hydroxide may be used instead of cesium salts. Formulations and main properties of the prototype composition are presented in the table. The data in the table clearly demonstrates that the gas (vapor) output of the claimed composition exceeds that of the prototype 2.8-11.9 times, in addition, the composition of the present invention does not corrode equipment made of ferrous materials, it is not flammable, nontoxic, and belongs to the low hazard category (4^{th} class) on the hazard rating scale.

Data on the qualitative and quantitative component content of the claimed binary chemical condensation composition is shown in Table 1.

TABLE 1

| | Patent | | | | | | |
|---|---|---|---|---|---|---|---|
| A. Composition | analog | | | | | | |
| components | RF | Content, wt. % | | | | | |
| B. Properties | 2393901 | 1 | 2 | 3 | 4 | 5 | 6 |
| 1 | 2 | 3 | 4 | 5 | 6 | 7 | 8 |
| A. Liquid ammonia | 8-10 | — | — | — | — | — | — |
| Water | 20-40 | — | — | — | — | — | — |
| Carbon dioxide + air | 3-7 | — | — | — | — | — | — |
| Phosphoric acid | 40-48 | — | — | — | — | — | — |
| Nitrogen propellant | remaining | — | — | — | — | — | — |
| Acid neutralizer | | | | | | | |
| Carbon dioxide | — | 56.0 | 49.5 | 38.8 | 56.0 | 49.5 | 38.8 |
| Nitrogen or air | — | 10.5 | 4.0 | 0.8 | 10.5 | 3.0 | 0.8 |
| Antifreeze: | — | | | | | | |
| Ethanol | — | 3.5 | 1.5 | — | — | 1.0 | 0.2 |
| Dimethyl ketone | — | — | — | 0.4 | 3.5 | 1.5 | 0.2 |
| Alkaline | | | | | | | |
| phlegmatizer | | | | | | | |
| Aqueous ammonia | — | 29.7 | 40.5 | 48 | 29.7 | 40.5 | 48 |
| Surfactant of AAAF | — | 0.3 | 2.5 | 6 | — | 1 | 2 |
| type | | | | | | | |
| Cesium chloride | — | — | 2.0 | — | — | — | — |
| Cesium sulfate | — | — | — | 6 | — | — | 2 |
| Cesium carbonate | — | — | — | — | 0.3 | — | 2 |
| Cesium iodide | — | — | — | — | — | 1.5 | 2 |
| Cesium bromide | — | — | — | — | — | 2 | 2 |
| Cesium phosphate | — | — | — | — | — | — | 2 |
| B. Properties | | | | | | | |
| 1. Yield of the | 0.2-0.34 | 0.95-2.38 | 0.95-2.38 | 0.95-2.38 | 0.95-2.38 | 0.95-2.38 | 0.95-2.38 |
| gaseous phlegmatizer | | | | | | | |
| with 1 kg of mixture, | | | | | | | |
| m³/kg | | | | | | | |
| 2. Corrosiveness to | + | − | − | − | − | − | − |
| ferrous materials | | | | | | | |

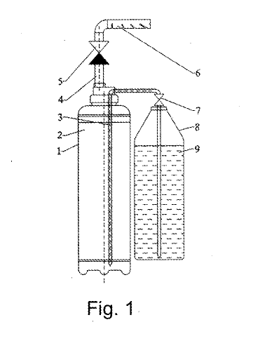

The apparatus with the claimed fire-fighting binary chemical condensation composition operates as follows (see FIG. 1):

Once received, a fire signal activates lock-and-release device 7 mounted on gas cylinder 8, and then acid propellant gas 9, for example carbon dioxide, flows through pipe aerator 3 into sealed tank 1 filled with alkaline chemical inhibitor 2, which exothermically reacts with the gaseous acidic propellant phlegmatizer producing a vapor-gas-dispersion fire-extinguishing mixture, which, in turn, creates pressure in tank 1, releases membrane valve 5, and the aforementioned mixture then enters the area of operation via outlet pipe 4 and slotted nozzle 6.

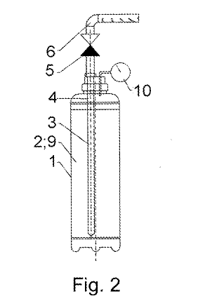

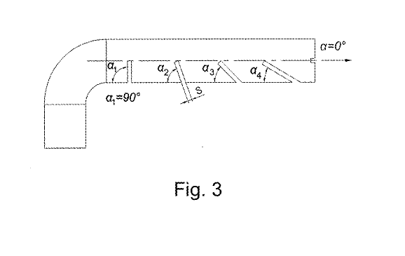

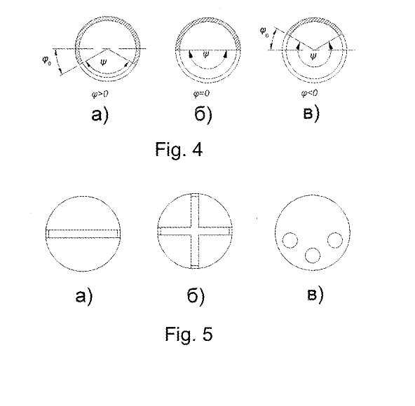

The apparatus shown on FIG. 2 operates in a similar manner except that gas-dispersion system (composition) 2,9 is not produced in a reaction but charged into sealed tank 1 already premixed. In addition, the tank comprises barometric pressure sensor 10.

### INDUSTRIAL APPLICABILITY

The present invention can be used in gas, chemical, petrochemical, wood-processing, and ore-mining industries as well as in civilian objects, homes, garages, and offices for preventing and extinguishing fires of flammable gases, liquids, and solids.

What is claimed:

1. A fire-extinguishing binary chemical condensation composition comprising a gaseous phlegmatizer propellant carbon dioxide mixed with nitrogen or air; a liquid alkaline phlegmatizer aqueous ammonia or derivatives thereof; and an acid neutralizer, wherein said alkaline phlegmatizer is a mixture of aqueous ammonia with the chemical formula NH₃xnH₂O, where n=0.5÷4 and a neutral inhibitor—namely, a fluorinated film-forming foaming agent and/or a cesium salt solution in the following volumetric ratio: aqueous ammonia/neutral inhibitor: from 99:1 to 80:20 respectively; and the acid neutralizer/propellant mixture is a mixture of carbon dioxide, a pressure stabilizer—namely, nitrogen or air, and antifreeze in the following volumetric ratio: carbon dioxide/pressure stabilizer/antifreeze: from 80:15:5 to 97:2:1 respectively, in the following composition component ratios (wt. %):
alkaline phlegmatizer with neutral inhibitor: 30-60,
acid neutralizer/propellant: remaining

2. The fire-extinguishing binary chemical condensation composition according to claim 1, wherein said cesium salt is cesium halogenide, or sulfate, or phosphate, or carbonate, and said antifreeze is alkyl carbinol and/or alkyl ketone.

3. An apparatus for extinguishing fires caused by flammable gases, liquids, and solids, comprising a tightly sealed tank containing a chemical inhibitor; a gas source as a gas cylinder connected to the interior of said tank with a pipe aerator, which facilitates the injection of said fire-fighting composition through a lock-and-release device (LRD); and an outlet pipe connected to the pipe atomizer nozzle via a membrane, mechanical, or electric valve, wherein said atomizer nozzles are slotted with at least 3 slots having tapering inclination angles relative to the horizontal, wherein the nozzle most remote from the atomizer end is perpendicular to the horizontal, the dispersion vector of the end atomizer nozzle is parallel to the horizontal, and the slant height of the slots is calculated as follows:
$${l}_{i} = 2 {\int }_{{ϕ}_{0}}^{90} \sqrt{1 + {tg}^{2} {α}_{i} \cdot cos ϕ} d ϕ ,$$
where I
I₁— slant height of the i-th slot, m
α—inclination angle of the i-th slot, degree
φ—end aperture angle of the slot, degree
$${ϕ}_{0} = \frac{{180}^{0} - ψ}{2} , rpa ;$$
degree
While the slot width is calculation as follows:
$$δ = \frac{\cdot {S}_{TP} - {S}_{T}}{2 {\sum }_{i = 1}^{n} {\int }_{{ϕ}_{0}}^{{90}^{0}} \sqrt{1 + {tg}^{2} α \cdot cos ϕ} d ϕ}$$
where δ is the width of the i-th slot, m
K_{D}—orificing factor of the atomizer, which is calculated as a ratio between the cumulative sum of the nozzle atomizer areas Sₐₜₒₘ, m² and the end area of the outlet pipe S_{T}_{ₚ}m²;
S_{T}—area of the end nozzle of the atomizer, m².

4. The apparatus according to claim 3, wherein the chemical inhibitor in the sealed tank is alkaline, the propellant gas in the cylinder is acidic, and when mixed, they produce an exothermic reaction.

5. The apparatus according to claim 3, wherein the gas dispersion composition with neutral ingredients comprises a solid and/or liquid inhibitor and a gaseous phlegmatizer propellant in the same tank, said tank is supplied with a pressure-controlling device.
